(19) United States
(12) Patent Application Publication
(10) Pub. No.: US 2026/0267000 A1
(43) Pub. Date: Sep. 10, 2026

(54) Eye Safe Lidar

(71) Applicant: Microvision, Inc., Redmond, WA (US)

(72) Inventors: Rejin Joy, Redmond, WA (US); Christopher Cannon, Redmond, WA (US)

(73) Assignee: Microvision, Inc., Redmond, WA (US)

(21) Appl. No.: 19/071,663

(22) Filed: Mar. 5, 2025

(51) Int. Cl. G01S 17/89; G01S 7/481; G01S 7/4865; G01S 17/931

(52) U.S. Cl. CPC G01S 17/89; G01S 7/4813; G01S 7/4814; G01S 7/4816; G01S 7/4817; G01S 7/4865; G01S 17/931

(57) ABSTRACT

Aspects of the subject disclosure may include, for example, a laser light source, optical devices forming a fanned beam, and scanning mirrors for a two-dimensional scan pattern. The system enhances eye safety by spacing overlapping laser pulses, with pixel matching in an arrayed receiver to ensure precise time-of-flight measurements. Other embodiments are disclosed.

### FIELD OF THE DISCLOSURE

The subject disclosure relates to light detection and ranging (LIDAR) systems that scan laser light pulses in a field of view.

### BACKGROUND

Systems that detect and measure distances to objects are widely used for various applications, including autonomous vehicles, robotics, and environmental mapping. These systems typically rely on scanning light across a field of view to gather spatial information. However, ensuring safety for human eyes while maintaining high performance remains a significant challenge. Traditional systems often employ methods to prevent emissions from exceeding safety limits. These methods, while effective, can be complex and costly, and may require intricate calibration processes that can be prone to errors, especially in adverse environmental conditions..

### BRIEF DESCRIPTION OF THE DRAWINGS

Reference will now be made to the accompanying drawings, which are not necessarily drawn to scale, and wherein:

FIG. 1 shows a LIDAR system that emits eye safe light pulses in accordance with various aspects described herein;

FIG. 2 shows an automotive application of a LIDAR system that emits eye safe light pulses in accordance with various aspects described herein;

FIG. 3 shows a block diagram of a control circuit in accordance with various aspects described herein;

FIG. 4 shows a diagram of eye safe light pulses in accordance with various aspects described herein;

FIG. 5 shows two eye safe pulses being reflected onto a multi-pixel detector in accordance with various aspects described herein;

FIG. 6 shows a diagram of pixel alignment on a multi-pixel detector in accordance with various aspects described herein;

FIG. 7 depicts an illustrative embodiment of a method in accordance with various aspects described herein;

FIG. 8 shows a side view of a transmit module in accordance with various aspects described herein;

FIG. 9 shows a top view of a transmit module in accordance with various aspects described herein;

FIG. 10 shows a side view of a receive module in accordance with various aspects described herein;

FIG. 11 shows a top view of a receive module in accordance with various aspects described herein;

FIG. 12 shows a perspective view of an integrated photonics module in accordance with various aspects described herein;

FIG. 13 shows a cross sectional top view of the integrated photonics module of FIG. 11; and

FIG. 14 depicts an illustrative embodiment of a method in accordance with various aspects described herein.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. Like numerals in the drawings refer to the same or similar functionality throughout the several views.

Various embodiments described herein provide a novel approach to achieving eye safety in LIDAR systems by modifying the pulsing mechanism. In contrast to tradition LIDAR systems that may produce time-dense laser light pulse trains, various embodiments described herein produce a continuous stream of laser light pulses that are spaced further apart in time. By increasing the time interval between pulses, the integrated energy that could potentially harm the eye is significantly reduced. This approach allows the system to remain within eye safety limits without the need for additional protective measures, making the system simpler and more cost-effective.

In some embodiments, the eye safety of the pulses is achieved by spreading the pulses over a longer time period. For example, in some embodiments, pulses are spread beyond the 5-microsecond (us) window where the safe limit increases almost linearly. As mentioned above, some traditional LIDAR systems produce multiple high-energy pulses emitted in quick succession, which can be potentially harmful if the integrated energy falls on an eyeball. By spacing these pulses further apart, various embodiments described herein ensures that the hazard of each pulse is similar to that of an individual event instead of a hazard accumulated over multiple pulses, reducing the risk of exceeding eye safety thresholds. These embodiments not only enhance safety but also allow for greater flexibility in pulse energy management, as the system can adjust the pulse timing to suit different operational requirements without compromising safety.

Various embodiments described herein include pixel-to-pixel matching logic, which addresses the challenges posed by the new pulsing mechanism. In some prior systems, a short pulse train is emitted in rapid succession, assuming that all pulses in a train would impact the same spatial location due to their density in time. However, various embodiments described herein produce laser light pulses having an offset in space and time. Various embodiments scan the laser light pulses in a direction that is parallel to an arrayed receiver having a plurality of light sensitive devices (e.g., a Silicon Photomultiplier, or SiPM, array). Various embodiments match returns from successive pulses to neighboring SiPM pixels, rather than assuming all pulses impact the same pixel. This pixel-to-pixel matching logic maintains accuracy and reliability in the presence of spatial and temporal offsets.

Following the pixel-to-pixel matching logic, the system performs time-of-flight (TOF) measurements to determine the distance to objects reflecting the laser pulses. The TOF measurement provides the data necessary to construct a three-dimensional map of the environment. In various embodiments described herein, the TOF measurement is enhanced by the precise matching of pulses to specific SiPM pixels, ensuring that the timing information is accurately correlated with the spatial location of the reflection. This precise correlation allows the system to calculate the round-trip time of each pulse with high accuracy, resulting in more reliable distance measurements and improved resolution of the scanned environment.

One or more aspects of the subject disclosure include a light detection and ranging system, comprising a laser light source to produce laser light pulses; at least one optical device to form the laser light pulses into a fanned beam, where the fanned beam diverges more on a first axis than on a second axis; a first scanning mirror assembly to scan the fanned beam on the first axis and the second axis and along a scanning trajectory to generate a two-dimensional scan pattern over a field of view such that each laser light pulse in the fanned beam impacts the scanning trajectory at a plurality of measurement points along the second axis of the fanned beam; an arrayed receiver that includes a plurality of light sensitive devices; a second scanning mirror assembly to scan on the first axis and the second axis and direct reflections of the fanned beam from the plurality of measurement points along the second axis of the fanned beam onto the plurality of light sensitive devices of the arrayed receiver; and a control circuit to match measurement points to the plurality of light sensitive devices of the arrayed receiver for successive ones of the laser light pulses.

Additional aspects of the subject disclosure may include the light detection and ranging system further comprising at least one time-of-flight measurement circuit, which is responsive to the control circuit to determine distances to objects reflecting the fanned beam at the measurement points. The arrayed receiver in the system may comprise either a one-dimensional or a two-dimensional array of light sensitive devices, providing flexibility in design and application. Each of the laser light pulses is designed to be eye safe individually, and they are spread out in time such that the combination of the laser light pulses remains eye safe, ensuring compliance with safety standards. The laser light pulses are spaced in time such that they are eye-safe, and the arrayed receiver includes at least 10 light sensitive devices, enhancing the system's resolution and accuracy. Furthermore, the first scanning mirror assembly is configured to scan faster on the second axis than on the first axis, optimizing the scanning efficiency and coverage of the field of view.

One or more aspects of the subject disclosure include a system comprising a laser light source to produce eye safe laser light pulses to illuminate a plurality of measurement points in a field of view; at least one optical device to form the eye safe laser light pulses into a fanned beam, wherein each laser light pulse in the fanned beam illuminates a different subset of the plurality of measurement points, and wherein subsets of the plurality of measurement points for successive laser light pulses overlap; a first scanning mirror assembly to scan the fanned beam on two axes and along a scanning trajectory to generate a two-dimensional scan pattern over a field of view that includes the plurality of measurement points; an arrayed receiver that includes a plurality of light sensitive devices; a second scanning mirror assembly to scan on the two axes and direct reflections of the fanned beam onto the plurality of light sensitive devices of the arrayed receiver; and a control circuit to match overlapping measurement points to the plurality of light sensitive devices of the arrayed receiver for the successive laser light pulses.

Additional aspects of the subject disclosure may include the system further comprising at least one time-of-flight measurement circuit, which is responsive to the control circuit to determine distances to objects reflecting the fanned beam at the measurement points. The arrayed receiver may be configured as either a one-dimensional or a two-dimensional array of light sensitive devices, offering versatility in system design and application. The eye safe laser light pulses are strategically spread out in time to ensure that the combination of these pulses remains eye safe, adhering to safety standards. These pulses are spaced in time such that they are eye-safe, and the arrayed receiver includes at least 10 light sensitive devices, which enhances the system's resolution and accuracy. Additionally, the first scanning mirror assembly is designed to scan faster on an axis parallel to the arrayed receiver, optimizing the scanning process and improving the system's overall performance.

One or more aspects of the subject disclosure include a method comprising producing a pulsed beam of laser light; forming the pulsed beam of laser light into a fanned beam having a wider divergence on a first axis than on a second axis; scanning the pulsed beam of laser light on the first axis and the second axis in a field of view such that the fanned beam illuminates a plurality of measurement points in the field of view; receiving a reflection of the fanned beam and imaging the reflection onto an arrayed receiver with a plurality of light sensitive devices; and determining which light sensitive devices correspond to different measurement points for successive laser light pulses in the pulsed beam of laser light.

Additional aspects of the subject disclosure may include the method wherein producing the pulsed beam of laser light comprises producing a plurality of eye safe laser light pulses, with the fanned beam associated with successive ones of these pulses overlapping in the field of view. The method may further comprise measuring a time-of-flight of the reflection of the fanned beam for each of the different measurement points, providing precise distance measurements. The imaging of the reflection onto the arrayed receiver may involve imaging onto either a one-dimensional or a two-dimensional array of light sensitive devices, offering flexibility in the system's design and application. Additionally, the pulsed beam of laser light includes a plurality of eye safe laser light pulses spaced sufficiently such that it ensures that the combination of these pulses remains within eye safety standards while enhancing the system's resolution and accuracy.

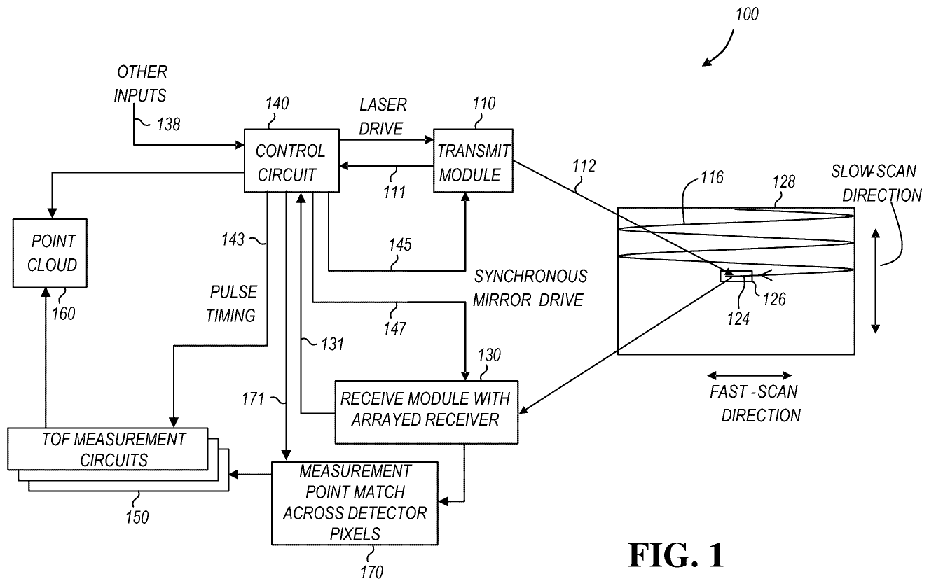

FIG. 1 shows a LIDAR system with scanning mirror assemblies in accordance with various aspects described herein. System 100 includes control circuit 140, transmit module 110, receive module 130, time-of-flight (TOF) measurement circuits 150, point cloud storage device 160, and measurement point match across detector pixels 170.

Transmit module 110 emits a scanning pulsed laser beam 112 that traverses a field of view 128 in two dimensions. In some embodiments, the scanning pulsed laser beam is collimated into a point beam. Further, in some embodiments, the scanning pulsed laser beam 112 is a fanned beam. The shape of the fanned beam is shown at 124, and the scanning trajectory that the pulsed laser beam takes through the field of view is shown at 116. In some embodiments, to produce the scanning pulsed fanned beam, transmit module 110 includes a laser light source to produce a pulsed laser beam, collimating and focusing optics to shape the pulsed laser beam into a pulsed fanned laser beam, and one or more scanning mirror assemblies to scan the pulsed fanned laser beam in two dimensions in the field of view. Example embodiments of transmit modules are described more fully below with reference to later figures.

In some embodiments, receive module 130 includes an arrayed receiver that includes a plurality of light sensitive devices. Receive module 130 also includes optical devices and one or more scanning mirror assemblies to scan in two dimensions and to direct reflected light from the field of view to the arrayed receiver. As shown in FIG. 1, receive module 130 captures reflected light from an aperture 126 that encompasses the location of the fanned beam in the field of view. Example embodiments of receive modules are described more fully below with reference to later figures.

The reflected fanned beam becomes “discretized” by the array of light sensitive devices, and the corresponding points in the field of view from which the beam is reflected are referred to herein as “measurement points.”

As used herein, the term “fanned beam” refers to a beam of light that has been purposely shaped to encompass more measurement points in one dimension than in another dimension. For example, as shown in FIG. 1, fanned beam 112 includes shape 124 that encompasses more measurement points in the horizontal dimension than in the vertical dimension. Although fanned beam embodiments are further described below, the subject matter described herein is not limited to fanned beam embodiments. For example, in some embodiments, the scanning pulsed laser beam 112 may be a collimated beam that is not fanned in either dimension.

Embodiments represented by FIG. 1 improve eye safety by spacing laser light pulses sufficiently apart in time. This approach mitigates the risk of harmful energy exposure by ensuring that each pulse is treated as an individual event, thereby reducing the integrated energy that could potentially impact the eye. By spacing the pulses beyond the 5-microsecond window, the system remains within eye safety limits without the need for additional protective measures. This method not only enhances safety but also allows for greater flexibility in pulse energy management, as the system can adjust the pulse timing to suit different operational requirements without compromising safety.

Various embodiments, in part because of the time spacing of laser light pulses, emit fanned beam laser light pulses that overlap with one another. Accordingly, a particular measurement point in the field of view may be illuminated by successive fanned beam laser light pulses, although the particular measurement point may find itself in a different portion of the fanned beam for successive laser pulses. The fanned beam, which diverges more on one axis than the other, allows each laser light pulse to illuminate a different subset of measurement points, with successive pulses overlapping these subsets. Accordingly, a single measurement point may correspond to different pixels in the arrayed receiver for a number of successive laser light pulses.

The measurement point match across detector pixels 170 functions to match pixels in the arrayed detector to measurement points for successive pulses. This function ensures that the timing and spatial information from each pulse is accurately correlated with the corresponding measurement points. By aligning the returns from successive pulses to neighboring pixels in the detector, the system can effectively manage the spatial and temporal offsets introduced by the pulse spacing. This precise matching enhances the reliability and accuracy of the time-of-flight measurements, resulting in a more detailed and accurate three-dimensional map of the scanned environment.

Time-of-flight (TOF) measurement circuits 150 are coupled to measurement point match across detector pixels 170 to measure a time-of-flight of detections made by different pixels in the arrayed receiver for successive laser light pulses. TOF measurement circuits 150 receive laser light pulse timing information 143 from control circuit 140 and compare it to the timing of received laser light pulses to measure round trip times-of-flight of light pulses, thereby measuring the distance (Z) to the point in the field of view from which the laser light pulse was reflected. Accordingly, TOF measurement circuits 150 measure the distance between LIDAR system 100 and measurement points in the field of view at which light pulses from the scanned fanned beam are reflected.

TOF measurement circuits 150 may be implemented with any suitable circuit elements. For example, in some embodiments, TOF measurement circuits 150 include digital and/or analog timers, integrators, correlators, comparators, registers, adders, or the like to compare the timing of the reflected laser light pulses with the pulse timing information received from control circuit 140.

Point cloud storage 160 receives TOF information corresponding to distance (Z) information from TOF measurement circuits 150. In some embodiments, the TOF measurements are held in point cloud storage 160 in an array format such that the location within point cloud storage 160 indicates the location within the field of view from which the measurement was taken. In other embodiments, the TOF measurements held in point cloud storage 160 include (X, Y) position information as well as TOF measurement information to yield (X, Y, Z) as a three dimensional (3D) data set that represents a depth map of the measured portion of the field of view 128. The point cloud data may then be used for any suitable purpose. Examples include 3D imaging, velocity field estimation, object recognition, adaptive field of view modifications, and the like.

Point cloud storage 160 may be implemented using any suitable circuit structure. For example, in some embodiments, point cloud storage 160 is implemented in a dual port memory device that can be written on one port and read on a second port. In other embodiments, point cloud storage 160 is implemented as data structures in a general purpose memory device. In still further embodiments, point cloud storage 160 is implemented in an application specific integrated circuit (ASIC).

Control circuit 140 determines laser drive properties and drives transmit module 110 with signal(s) that cause the light source to emit laser light pulses having the specified properties. For example, control circuit 140 may determine values for laser drive power, pulse rate, pulse width, and number of multishot pulses. Further, control circuit 140 may adaptively modify the laser drive properties in response to feedback from any of the functional blocks depicted in FIG. 1 or in response to other inputs 138.

Control circuit 140 also controls the movement of scanning mirrors within transmit module 110 and receive module 130. In operation, control circuit 140 receives mirror position feedback information 111 from transmit module 110, and also receives mirror position feedback information 131 from receive module 130. The mirror position feedback information is used to phase lock the operation of the mirrors. Control circuit 140 drives microelectromechanical (MEMS) assemblies with scanning mirrors within transmit module 110 with drive signal(s) 145 and also drives MEMS assemblies with scanning mirrors within receive module 130 with drive signal(s) 147 that cause the mirrors to move non-resonantly through angular extents of mirror deflection with angular offsets that define the size and location of field of view 128. Control circuit 140 synchronizes the movement between mirrors in transmit module 110 and receive module 130 so that area 126 is continually positioned in the field of view to receive light reflected from objects that are illuminated with pulsed fanned beam 112. The synchronization of transmit and receive scanning allows the receive aperture to only accept photons from the portion of the field of view where the transmitted energy was transmitted. This results in significant ambient light noise immunity.

In some embodiments, control circuit 140 also provides control 171 to measurement point match across detector pixels 170. For example, different pixels in the arrayed receiver may be matched for successive laser light pulses based on pulse spacing, the number of light sensitive devices in the arrayed receiver, the speed of the scanning mirrors, and the like. In some embodiments, control circuit 140 may dynamically change which pixels are matched for successive laser light pulses based on changes to the aforementioned variables.

Control circuit 140 is implemented using functional circuits such as phase lock loops (PLLs), filters, adders, multipliers, registers, processors, memory, and the like. Accordingly, control circuit 140 may be implemented in hardware, software, or in any combination. For example, in some embodiments, control circuit 140 is implemented in an application specific integrated circuit (ASIC). Further, in some embodiments, some of the faster data path control is performed in an ASIC and overall control is software programmable.

As shown in FIG. 1, the two dimensional scanning is performed in a first dimension (horizontal, fast scan direction) and a second dimension (vertical, slow scan direction). The labels “vertical” and “horizontal” are somewhat arbitrary, since a 90 degree rotation of the apparatus will switch the horizontal and vertical axes. Accordingly, the terms “vertical” and “horizontal” are not meant to be limiting.

The scanning trajectory in the fast scan direction is shown as sinusoidal, and the scanning trajectory in the slow scan direction is shown as constant velocity, although this is not a limitation. In some embodiments, all mirror motion is operated non resonantly. Accordingly, a relatively flat control band exists down to and including 0Hz. This allows a drive signal to be generated to cause the pointing angle (boresight) of the LIDAR system to deflect to a desired position in two dimensions (azimuth & elevation) of a spherical coordinate space, offset from the mirror relaxation point.

The angular extents of mirror deflection of both the transmit and receive modules can be adjusted to change the active field of view of the LIDAR system. The scanning mirror assemblies are designed for reliable operation at some maximum angle of deflection along each scan axis. From that nominal/max operating point, the drive amplitude may be reduced to collapse the deflection angle and narrow the active field of view. All else being equal, this results in a proportional increase in the angular resolution of the acquired scene.

In some embodiments, it is beneficial to trade off surplus angular resolution for increased range of measurement. For example, reducing the pulse repetition rate allows for a longer flight time in between adjacent pulses, eliminating range aliasing out to a proportionally larger distance. Accordingly, a balance exists such that reducing the field of view increases the non-ambiguous range of the LIDAR system without changing the angular resolution of the acquired scene. In some embodiments, laser power modifications are performed as a complement to increased range. For example, the laser power may be scaled as the square of the proportional increase in range.

Though the scanned field of view, pulse repetition rate, and laser power may all be independently controlled by software configuration, in some embodiments, it may be desirable to also design them to be commanded in a coordinated manner, automatically under hardware control.

Pulse width may also be controlled in the same manner in order to augment the scaled distance of interest. As the pulse width is increased, additional energy is deposited into the scene, increasing the likelihood of a sufficient number of photons returning to the receiver to trip the detection threshold. In some embodiments, increasing the pulse width is only performed when the peak power is maxed out as a wider pulse increases time resolution error for weak returns. This tradeoff is often warranted and useful as absolute time/distance resolution is typically not as important as percentage error which self-normalizes with distance.

Pulse energy may also be augmented by means of a train of shorter multishot pulses. The number of pulses may be varied to achieve the desired amount of energy in addition to or in place of modification of the pulse width.

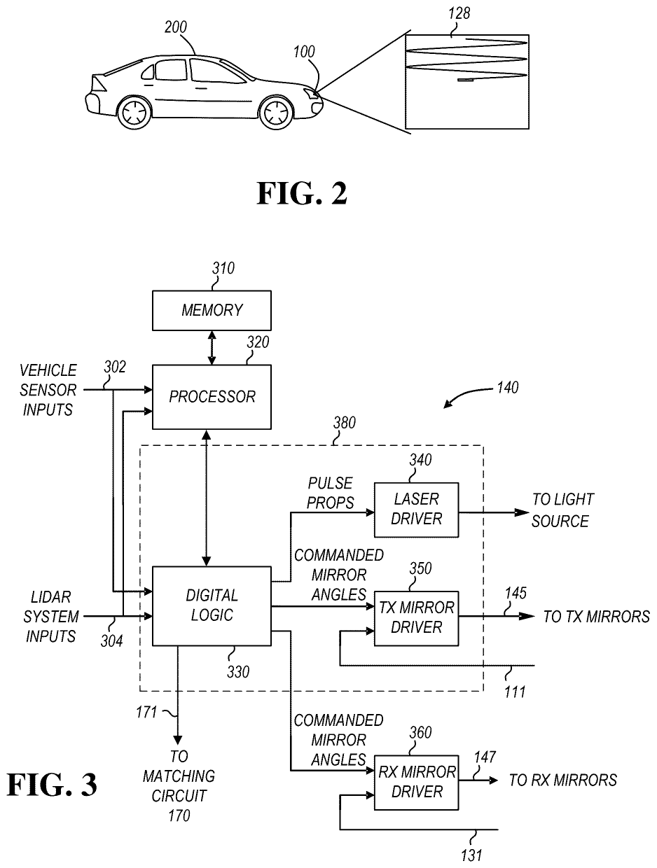

FIG. 2 shows an automotive application of a LIDAR system with scanning mirror assemblies in accordance with various aspects described herein. As shown in FIG. 2, vehicle 200 includes LIDAR system 100 at the front of the vehicle. LIDAR system 100 synchronously scans transmit and receive scanning mirrors such that receiver aperture 126 substantially overlaps the shape 124 of the pulsed fanned beam. Although much of the remainder of this description describes the LIDAR system in the context of an automotive application, the various embodiments described herein are not limited in this respect.

FIG. 3 shows a block diagram of a control circuit in accordance with various aspects described herein. The example embodiment shown in FIG. 3 corresponds to a control circuit that may be included when LIDAR system 100 is used in an automotive application. Other control circuit embodiments may be employed when used in applications other than automotive applications. Control circuit 140 includes processor 320, memory 310, transmit control circuitry 380, and receive mirror driver 360. Transmit control circuitry includes digital logic 330, laser driver 340, and transmit mirror driver 350. Control circuit 140 receives vehicle sensor inputs at 302 and LIDAR system inputs at 304. Vehicle sensor inputs may include any type of data produced by sensors on a vehicle. Examples include data describing vehicle position, speed, acceleration, direction. Other examples include sensor data received from adaptive driver assistance systems (ADAS) or other vehicle mounted sensors. LIDAR system inputs may include any data gathered or produced by the LIDAR system. Examples include computer vision processing results, internal inertial measurement unit data, and the like.

Processor 320 may include any type of processor capable of executing instructions stored in a memory device. For example, processor 320 may be a microprocessor, a digital signal processor, or a microcontroller. Processor 320 may also be a hard-coded processor such as a finite state machine that provides sequential flow control without fetching and executing instructions.

Memory 310 may be any device that stores data and/or processor instructions. For example, memory 310 may be a random access memory device that stores data. In some embodiments, memory 310 is a non-transitory storage device that stores instructions, that when accessed by processor 320 result in processor 320 performing actions. For example, in some embodiments, processor 320 executes instructions stored in memory 310 and performs method embodiments.

Digital logic 330 receives vehicle sensor inputs at 302 and LIDAR system inputs at 304 and outputs information used to control a laser light source and scanning mirrors. Digital logic 330 may produce the outputs based solely on the vehicle sensor data and/or LIDAR system data, may produce the outputs based solely on interactions with processor 320, or may produce the outputs based on a combination of the vehicle sensor data, LIDAR system data, and interaction with processor 320. For example, in some embodiments, digital logic 330 modifies laser light pulse parameters such as pulse power, repetition rate, pulse width, and number of multishot pulses in response to vehicle sensor data and/or LIDAR system data. Also for example, in some embodiments, digital logic 330 modifies angular extents and angular offsets used to drive the scanning mirrors in the transmit module and receive module in response to vehicle sensor data and/or LIDAR system data.

In some embodiments, digital logic 330 provides output data under software control via interaction with processor 320. For example, processor 320 may determine values for any of the outputs in response to vehicle sensor data and/or LIDAR system data, and then command digital logic under software control. In other embodiments, digital logic 330 may provide output data under hardware control independent of processor 320. For example, an adaptive model may be programmed into digital logic 330 in advance, and digital logic 330 may then modify outputs as a function vehicle sensor data and/or LIDAR system data at a much faster rate.

Laser driver 340 receives laser light properties from digital logic 330 and drives the laser light source. For example, laser driver 340 may receive property values for pulse power, pulse repetition rate, pulse width, and number of multishot pulses, and produce an analog signal to drive a laser light source. Laser driver 340 may be implemented with any suitable circuit elements including for example, high speed signal generators, amplifiers, filters, and the like.

Mirror drivers 350, 360 receive commanded mirror angle information from digital logic 330 and mirror position feedback information 111, 131, and produce drive signals 145, 147 to cause scanning mirrors in modules 110, 130 to undergo motion. Transmit mirror driver 350 and receive mirror driver 360 may be implemented using any suitable circuit structures including for example, phase lock loops, numerically controlled oscillators, filters, amplifiers, and the like. In some embodiments, mirror position feedback information 111, 131 includes measured mirror angle information as well as measured temperature information. Mirror drivers use the measured temperature information to compensate for angle measurement errors as a function of temperature. These and other embodiments are further described below.

As described further below, in some embodiments, digital logic 330 drives matching circuit 170 with signals and/or commands to tell the matching circuit which pixels in the arrayed receiver correspond to a single measurement point in successive laser light pulses. These and other embodiments are further described below.

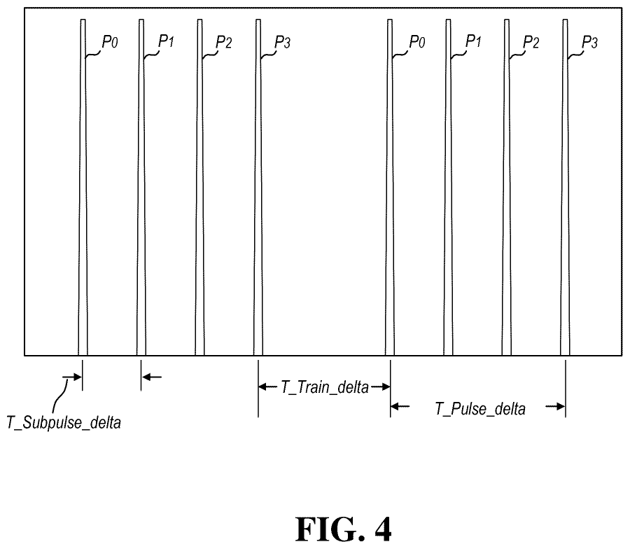

FIG. 4 shows a diagram of eye safe light pulses in accordance with various aspects described herein. The diagram of FIG. 4 shows a plot of laser light pulses time on the horizontal axis and pulse amplitude on the vertical axis. As shown in FIG. 4, various embodiments enhance eye safety by spacing the laser pulses further apart in time. Parameters depicted in FIG. 4 include T_Subpulse_delta, T_Pulse_delta, and T_Train_delta. T_Subpulse_delta refers to the time interval between any two consecutive pulses within a pulse train, while T_Pulse_delta represents the total time span from the first to the last pulse in the train, and T_Train_delta indicates the time between two consecutive pulse trains.

In the figure, two pulse trains are shown, each consisting of four pulses labeled P₀, P₁, P₂, and P₃. Although the figure depicts four pulses per train, the system is flexible and can accommodate any number of pulses per train. Various embodiments of this pulsing strategy provide a large enough T_Subpulse_delta and T_Pulse_delta to reduce T_Train_delta. By doing so, the various embodiments reduce the amount of energy that falls on an eyeball within a given period, thus minimizing potential harm. This approach allows each pulse to be treated as an individual event, significantly lowering the risk of exceeding eye safety thresholds.

The pulses depicted in FIG. 4 are designed to be eye safe by ensuring that each individual pulse, if it were to fall on an eye, remains within safe energy limits. The strategic spacing of the pulses further enhances safety by ensuring that even if two consecutive pulses were to impact the eye, the combined energy would still not exceed safety thresholds. For instance, by spacing the pulses at intervals of at least 5 microseconds, the system takes advantage of the fact that the safe energy limit increases almost linearly beyond this time window. This means that the energy from two pulses spaced by 5 microseconds or more is sufficiently dispersed over time, reducing the risk of harmful exposure. This careful consideration of pulse timing ensures that the LIDAR system operates safely without the need for additional protective measures, while still maintaining high performance and accuracy in distance measurement and environmental mapping. Five microseconds is used as an example of pulse spacing that may be eye-safe. In some embodiments, pulses spaced less that 5 microseconds may also be eye-safe based on the amount of energy in the pulse. For example, two half power pulses spaced at 2.5 microseconds may be as eye-safe as one full power pulse spaced at five microseconds.

The pulse spacing strategy illustrated in FIG. 4 not only ensures eye safety but also facilitates the overlap of successive fanned beam laser light pulses. In some embodiments, the fanned beam diverges more on one axis than the other, allowing each laser light pulse to illuminate a different subset of measurement points. Consequently, a particular measurement point in the field of view may be illuminated by successive pulses; however, due to the spatial and temporal offsets introduced by the pulse spacing, the same measurement point may correspond to different pixels in the arrayed receiver for each pulse. Various embodiments compensate for this using pixel-to-pixel matching logic to accurately correlate the timing and spatial information from each pulse with the corresponding measurement points, thereby enhancing the reliability and accuracy of the system's time-of-flight measurements.

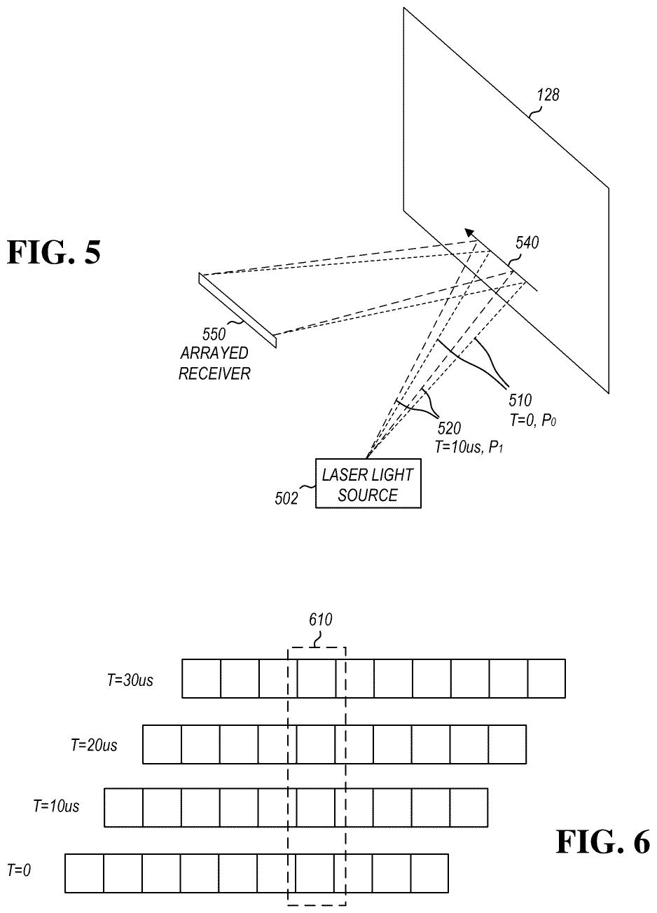

FIG. 5 shows two eye safe pulses being reflected onto a multi-pixel detector in accordance with various aspects described herein. FIG. 5 illustrates the concept of overlapping fanned beam laser light pulses within a LIDAR system. In this figure, 510 and 520 represent successive fanned beam laser light pulses, labeled as P₀ and P₁, respectively. These pulses overlap in the field of view, resulting in common measurement points are illuminated by both pulses. The arrayed receiver 550 is oriented parallel to the direction of the fast scan 540, which allows it to capture the overlapping regions effectively. At time T=0, laser light source 502 produces pulse 510 which illuminates a first subset of measurement points in field of view 128, and at T=10μs, pulse 520 follows, maintaining the overlap with the previous pulse. Accordingly, pulse 520 illuminates a second subset of measurement points, some of which are common with the first subset of measurement points illuminated by pulse 510. Both fanned beams are imaged onto the arrayed receiver 550 because the aperture, as described with reference to FIG. 1, dynamically follows the fanned beam through the operation of the scanning mirrors and optics. For clarity, the scanning mirrors and optics are not shown in this figure, but they play a role in ensuring that the arrayed receiver 550 continuously aligns with the fanned beam, capturing the reflected light from the measurement points accurately.

FIG. 6 shows a diagram of pixel alignment on a multi-pixel detector in accordance with various aspects described herein. FIG. 6 illustrates the alignment of pixels on the arrayed receiver 550 in the context of successive fanned beam laser light pulses. In the example of FIG. 6, the consecutive pulse spacing is 10 us, allowing for precise temporal separation between pulses. The fanned beam spans one degree in the fast scan direction, which is aligned parallel to the arrayed receiver. Further, in this example, the arrayed receiver is a 10-cell Silicon Photomultiplier (SiPM), corresponding to an arrayed receiver with 10 light sensitive devices. The width of the arrayed receiver is designed to cover 10 pixels within one degree of the field of view, with each pixel having a width of 0.1 degree. Although the example provided in FIG. 6 is described with arrayed receiver 550 having 10 cells (or light sensitive devices), the various embodiments described herein are not limited in this respect. For example, in some embodiments, arrayed receiver 550 may have less than 10 cells (e.g., 4 or 8), and in other embodiments, arrayed receiver 550 may have more than 10 cells (e.g., 12, 14, 16, etc.).

In FIG. 6, the alignment of pixels is depicted, showing how the same measurement point is illuminated by successive fanned beam laser light pulses. The pixels labeled as 610 represent those that correspond to the same measurement point across different pulses. This configuration ensures that as the fanned beam moves across the field of view, the arrayed receiver can accurately capture and correlate the reflected light from each measurement point, even as the beam progresses through its scanning trajectory. This alignment maintains the accuracy and reliability of the system's time-of-flight measurements, as it allows for effective pixel-to-pixel matching and ensures that the spatial and temporal information from each pulse is accurately recorded.

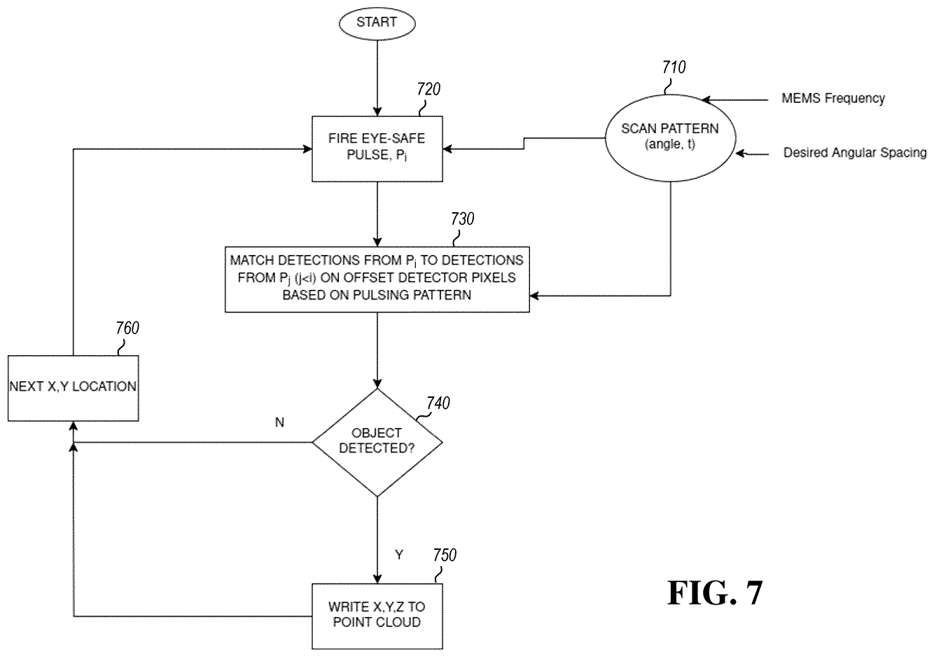

FIG. 7 depicts an illustrative embodiment of a method in accordance with various aspects described herein. Method 700 may be performed by components described with respect to previous figures, such as the control circuit 140 in combination with the matching function 170. At block 710, the method begins with the scan pattern, which involves determining the angle and time for scanning. In some embodiments, block 710 involves setting the parameters for the scanning trajectory to ensure comprehensive coverage of the field of view. For example, the control circuit may adjust the scanning mirrors to achieve the desired angular spacing and MEMS frequency.

At block 720, the method involves firing an eye-safe pulse, Pi. In some embodiments, block 720 ensures that each laser pulse emitted is within eye safety limits. For example, the laser light source may be controlled to emit pulses that are spaced sufficiently apart to prevent harmful energy exposure. At block 730, the method matches detections from Pi to detections from Pj (where i>j) on offset detector pixels based on the pulsing pattern. In some embodiments, block 730 involves correlating the timing and spatial information from successive pulses to ensure accurate measurement point matching. For example, the control circuit 140 may use pixel-to-pixel matching logic to align returns from different pulses to neighboring pixels in the arrayed receiver as shown in FIG. 6.

At block 740, the method checks if an object is detected. In some embodiments, block 740 involves analyzing the reflected signals to determine the presence of objects within the scanned area. For example, the system may use time-of-flight measurements to identify objects based on the timing of the received pulses.

At block 750, if an object is detected, the method writes the X, Y, Z coordinates to the point cloud. In some embodiments, block 750 involves storing the spatial data of detected objects for further processing. For example, the point cloud storage device may record the three-dimensional coordinates to construct a detailed map of the environment.

At block 760, the method proceeds to the next X, Y location. In some embodiments, block 760 involves updating the scanning trajectory to continue the scanning process. For example, the control circuit may adjust the scanning mirrors to move to the next set of measurement points, ensuring continuous coverage of the field of view.

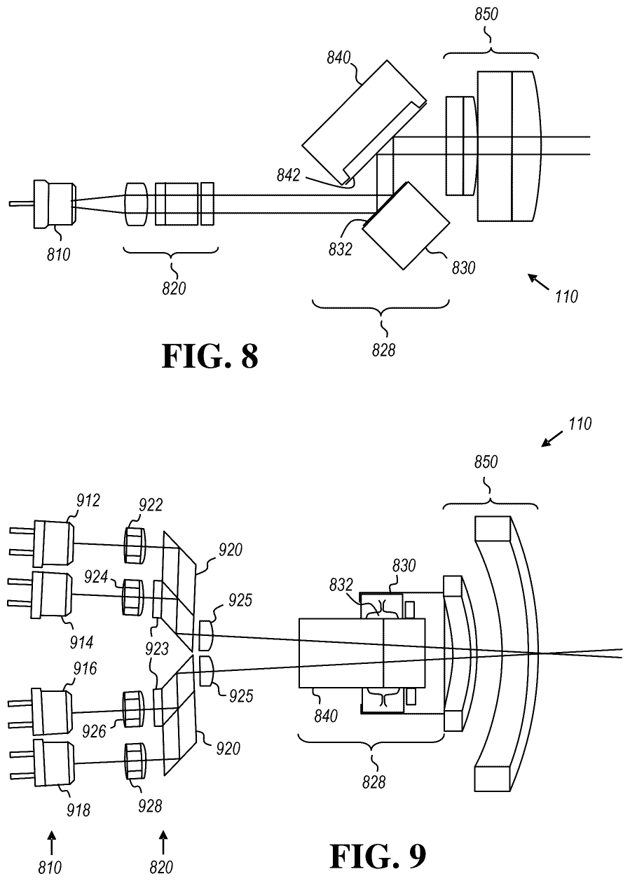

FIG. 8 shows a side view and FIG. 9 shows a top view of a transmit module in accordance with various aspects described herein. Transmit module 110 includes laser light source 810, beam shaping optical devices 820, scanner 828, and exit optical devices 850.

In some embodiments, laser light source 810 sources nonvisible light such as infrared (IR) light. In these embodiments, the receive module 130 (FIG. 1) is able to detect the same wavelength of nonvisible light. For example, in some embodiments, light source 810 may include a laser diode that produces infrared light with a wavelength of substantially 905 nanometers (nm), and receive module 130 detects reflected light pulses with a wavelength of substantially 905 nm. Also for example, in some embodiments, light source 810 may include a laser diode that produces infrared light with a wavelength of substantially 940 nanometers (nm) and receive module 130 detects reflected light pulses with a wavelength of substantially 940 nm. The wavelength of light is not a limitation of the various embodiments. Any wavelength, visible or nonvisible, may be used without departing from the scope of the various embodiments described herein.

Laser light source 810 may include any number or type of emitter suitable to produce a pulsed fanned laser beam. For example, in some embodiments, laser light source 810 includes multiple laser diodes shown in FIG. 9 at 912, 914, 916, and 918. In some embodiments, the pulsed laser light produced by laser light source 810 is combined, collimated, and focused by beam shaping optical devices 820 to produce a pulsed fanned laser beam. For example, optical devices 922, 924, 926, and 928 may collimate the laser beams on the slow axis, polarization rotators 923 and beam combiners 920 may combine laser beams, and optical devices 925 may form the pulsed laser beam into a fan on the fast axis. In some embodiments, the pulsed laser beam may be focused to form the fanned beam, and in other embodiments, the pulsed laser beam may be expanded to form the fanned beam. In some embodiments, optical devices 925 may be line generator optics to form the pulsed laser beam into a fanned beam. In some embodiments, the pulsed laser beam may be collimated on the slow axis with <0.2 degrees of divergence and may be focused or expanded on the fast axis to diverge at a rate that produces a fan of substantially four degrees. Beam sizes and divergence values are not necessarily uniform across the various embodiments described herein; some embodiments have higher values, and some embodiments have lower values.

Scanner 828 receives the pulsed fanned laser beam from optical devices 820 and scans the pulsed fanned beam in two dimensions. In embodiments represented by FIGS. 8 and 9, scanner 828 includes two separate scanning mirror assemblies 830, 840, each including a scanning mirror 832, 842, where each scanning mirror scans the beam in one dimension. For example, scanning mirror 832 scans the pulsed fanned beam in the fast scan direction, and scanning mirror 842 scans the pulsed fanned beam in the slow scan direction.

Scanning mirror assemblies 830, 840 are driven by signals received from control circuit 140 (FIGS. 1, 3). For example, scanning mirror 832 may scan in one dimension according to a first commanded angle on the first dimension as a result of being driven by a first control signal, and scanning mirror 842 may scan in a second dimension according to a second commanded angle on the second dimension as a result of being driven by a second control signal. In some embodiments, the instantaneous angular deflection of scanning mirror assemblies 830 and 840 are independently controlled, resulting in a completely configurable field of view along with configurable scan rates.

Although scanner 828 is shown including two scanning mirror assemblies, where each scans in a separate dimension, this is not a limitation of the various embodiments described herein. For example, in some embodiments, scanner 828 is implemented using a single biaxial scanning mirror assembly that scans in two dimensions. In some embodiments, scanning devices uses electromagnetic actuation, achieved using a miniature assembly containing a MEMS die and small subassemblies of permanent magnets and an electrical interface, although the various embodiments are not limited in this respect.

Exit optical devices 850 operate on the scanning pulsed fanned laser beam as it leaves the transmit module. In some embodiments, exit optical devices 850 perform field expansion. For example, scanning mirror assembly 828 may scan through maximum angular extents of 40 degrees on the fast scan axis, and may scan through maximum angular extents of 20 degrees on the slow scan axis, and exit optical devices 1050 may expand the field of view to 120 degrees on the fast scan axis and 30 degrees on the slow scan axis. The relationship between scan angles of scanning mirrors and the amount of field expansion provided by exit optical devices 850 is not a limitation of the various embodiments described herein.

In some embodiments, laser diodes 912, 914, 916, and 918 are high power multimode laser diodes. Multimode laser diodes typically have relatively large emitter areas that result in a beam that diverges faster on one axis than on the other axis. For example, an example 905 nm multimode laser diode may have a 10 um emitter on the slow axis and a 220 um emitter on the fast axis resulting in an emitted beam that inherently diverges faster on the fast axis. Various embodiments take advantage of this non-uniform beam shape by collimating the beam on the axis that naturally diverges more slowly, and focusing the beam into a fan on the axis that naturally diverges more quickly.

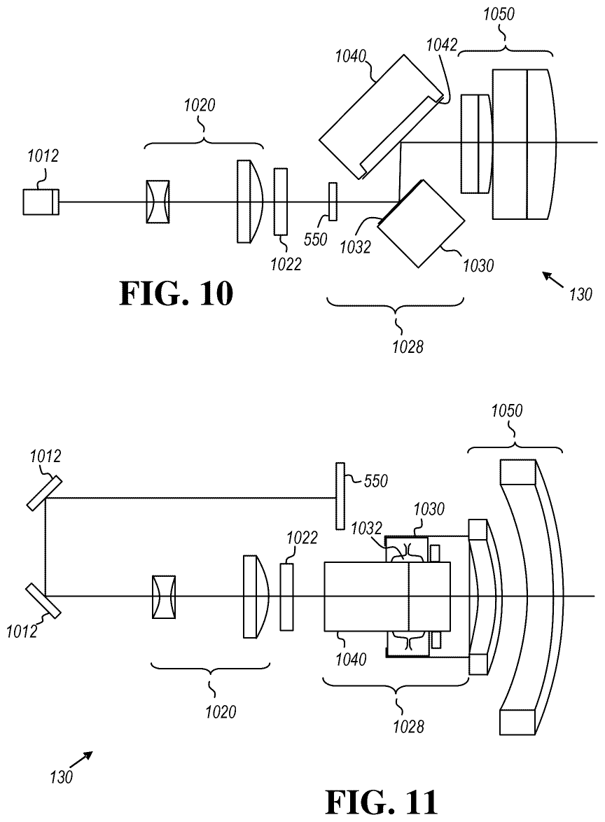

FIG. 10 shows a side view and FIG. 11 shows a top view of a receive module in accordance with various aspects described herein. Receive module 130 includes arrayed receiver 550, fold mirrors 1012, imaging optical devices 1020, bandpass filter 1022, scanner 1028, and exit optical devices 1050.

Scanning mirror assemblies 1030 and 1040 are similar or identical to scanning mirror assemblies 830 and 840, and exit optical devices 1050 are similar or identical to exit optical devices 850. Bandpass filter 1022 passes the wavelength of light that is produced by laser light source 810 and blocks ambient light of other wavelengths. For example, in some embodiments, laser light source produces light at 905 nm, and bandpass filter 1022 passes light at 905 nm.

Imaging optical devices 1020 image a portion of the field of view onto arrayed receiver 50 after reflection by fold mirrors 1012. For example, in some embodiments, optical devices 1020 image the area 126 (FIG. 1) onto arrayed receiver 550. Because scanner 1028 is scanned synchronously with scanner 828, arrayed receiver 550 always collects light from the measurement points illuminated by the scanned pulsed fanned beam.

Arrayed receiver 550 includes an array of light sensitive devices. The array of light sensitive devices may be one-dimensional or two-dimensional. For example, in some embodiments, arrayed receiver 550 includes a 1×M array of PIN photodiodes, Silicon photomultipliers (SiPM), avalanche photodiodes (APD), or the like, where M is any integer. Also for example, in some embodiments, arrayed receiver 550 includes a N×M array of PIN photodiodes, Silicon photomultipliers (SiPM), avalanche photodiodes (APD), or the like, where N and M are any integers. Any number of light sensitive devices may be included without departing from the scope of the various embodiments described herein. For example, in some embodiments, 16 light sensitive devices are included, and in other embodiments, 24 light sensitive devices are included.

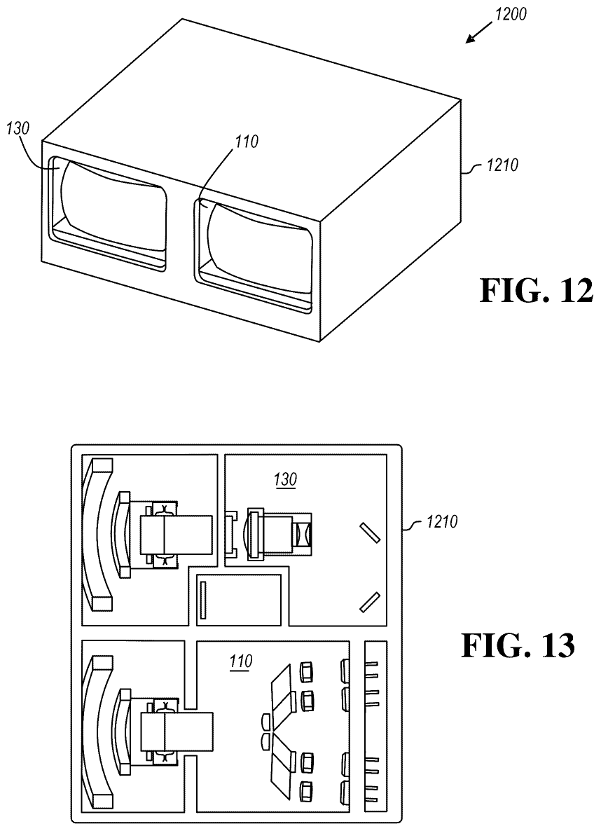

FIG. 12 shows a perspective view of an integrated photonics module in accordance with various embodiments described herein. Integrated photonics module 1200 is shown having a rectangular housing 1210 with transmit module 110 and receive module 130 placed side by side. In some embodiments, transmit module 110 and receive module 130 are placed one on top of the other. The relative orientation of transmit module 110 and receive module 130 is not a limitation of the various embodiments described herein.

FIG. 13 shows a cross sectional top view of the integrated photonics module of FIG. 12. Transmit module 110 and receive module 130 are shown side by side. In some embodiments, space is provided for electronics above and below the rearmost optical devices in integrated photonics module 1200. Any amount of system electronics may be included within module 1200. For example, in some embodiments, all components shown in FIG. 1 are included in module 1200. Also for example, in some embodiments, only control circuits and TOF measurement circuits are included in module 1400.

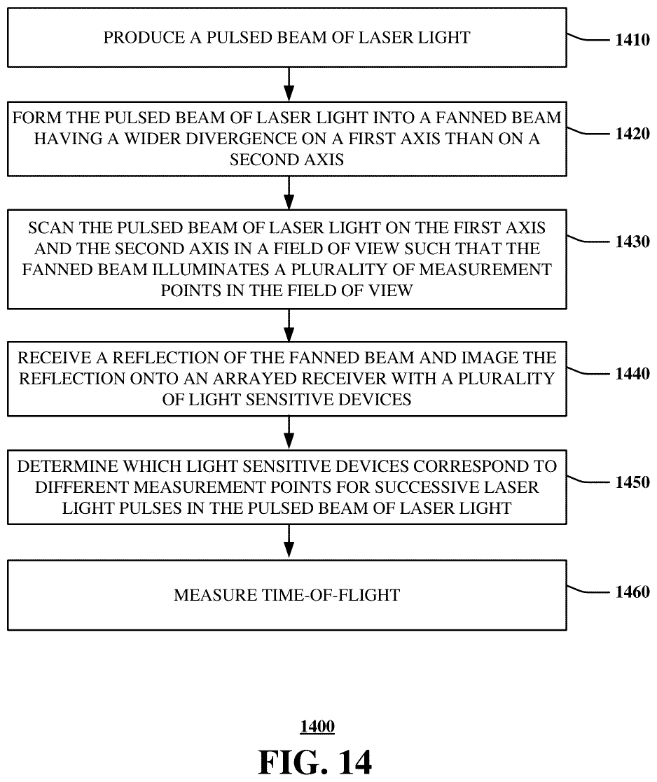

FIG. 14 shows a flow diagram of methods in accordance with various aspects described herein. In some embodiments, method 1400, or portions thereof, is performed by a MEMS system, a scanning LIDAR system, or a scanning LIDAR module. In other embodiments, method 1400 is performed by a series of circuits or an electronic system. Method 1400 is not limited by the particular type of apparatus performing the method. The various actions in method 1400 may be performed in the order presented or may be performed in a different order. Further, in some embodiments, some actions listed in FIG. 14 are omitted from method 1400.

At block 1410, method 1400 begins with producing a pulsed beam of laser light. In some embodiments, producing the pulsed beam of laser light comprises producing a plurality of eye safe laser light pulses. In some embodiments, block 1410 involves generating these eye safe pulses using a laser module, ensuring that each pulse remains within safety standards. For example, the laser module may produce pulses spaced by at least 5 microseconds to maintain eye safety.

At block 1420, the method involves forming the pulsed beam of laser light into a fanned beam having a wider divergence on a first axis than on a second axis. The fanned beam associated with successive pulses overlaps in the field of view, allowing for comprehensive coverage. In some embodiments, block 1420 includes shaping the beam using optical devices. For example, the beam may be collimated on one axis and expanded on another to create the fanned shape.

At block 1430, the method scans the pulsed beam of laser light on the first axis and the second axis in a field of view such that the fanned beam illuminates a plurality of measurement points. In some embodiments, block 1430 involves using scanning mirrors to direct the beam across the field. For example, the mirrors may be controlled to follow a specific trajectory to cover the desired area, ensuring that successive pulses illuminate overlapping measurement points.

At block 1440, the method receives a reflection of the fanned beam and images the reflection onto an arrayed receiver with a plurality of light sensitive devices. The imaging of the reflection may involve either a one-dimensional or a two-dimensional array, offering flexibility in the system's design and application. In some embodiments, block 1440 includes capturing the reflected light using the arrayed receiver. For example, the receiver may consist of a SiPM array that detects the light and converts it into electrical signals.

At block 1450, the method determines which light sensitive devices correspond to different measurement points for successive laser light pulses. In some embodiments, block 1450 involves matching the detected signals to specific measurement points. For example, the system may use pixel-to-pixel matching logic to correlate the signals with the spatial locations of the reflections, enhancing the system's resolution and accuracy.

At block 1460, the method measures the time-of-flight of the reflected light, providing precise distance measurements. In some embodiments, block 1460 includes calculating the distance to the measurement points based on the time it takes for the light to travel to the object and back. For example, the system may use timing circuits to determine the round-trip time and compute the distance, contributing to the creation of a three-dimensional map of the environment.

While for purposes of simplicity of explanation, the respective processes are shown and described as a series of blocks in FIG. 14, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A light detection and ranging system, comprising:
a laser light source to produce laser light pulses;
at least one optical device to form the laser light pulses into a fanned beam, where the fanned beam that diverges more on a first axis than on a second axis;
a first scanning mirror assembly to scan the fanned beam on the first axis and the second axis and along a scanning trajectory to generate a two-dimensional scan pattern over a field of view such that each laser light pulse in the fanned beam impacts the scanning trajectory at a plurality of measurement points along the second axis of the fanned beam;
an arrayed receiver that includes a plurality of light sensitive devices;
a second scanning mirror assembly to scan on the first axis and the second axis and direct reflections of the fanned beam from the plurality of measurement points along the second axis of the fanned beam onto the plurality of light sensitive devices of the arrayed receiver; and
a control circuit to match measurement points to the plurality of light sensitive devices of the arrayed receiver for successive ones of the laser light pulses.

2. The light detection and ranging system of claim 1, further comprising at least one time-of-flight measurement circuit, responsive to the control circuit to determine distances to objects reflecting the fanned beam at the measurement points.

3. The light detection and ranging system of claim 1, wherein the arrayed receiver comprises a one-dimensional array of light sensitive devices.

4. The light detection and ranging system of claim 1, wherein the arrayed receiver comprises a two-dimensional array of light sensitive devices.

5. The light detection and ranging system of claim 1, wherein each of the laser light pulses are by themselves eye safe, and the laser light pulses are spread out in time such that a combination of the laser light pulses are still eye safe.

6. The light detection and ranging system of claim 1, wherein the laser light pulses are spaced by at least 5 us, and the arrayed receiver includes at least 10 light sensitive devices.

7. The light detection and ranging system of claim 1, wherein the first scanning mirror assembly scans faster on the second axis than on the first axis.

8. A system comprising:
a laser light source to produce eye safe laser light pulses to illuminate a plurality of measurement points in a field of view;
at least one optical device to form the eye safe laser light pulses into a fanned beam, wherein each laser light pulse in the fanned beam illuminates a different subset of the plurality of measurement points, and wherein subsets of the plurality of measurement points for successive laser light pulses overlap;
a first scanning mirror assembly to scan the fanned beam on two axes and along a scanning trajectory to generate a two-dimensional scan pattern over a field of view that includes the plurality of measurement points;
an arrayed receiver that includes a plurality of light sensitive devices;
a second scanning mirror assembly to scan on the two axes and direct reflections of the fanned beam onto the plurality of light sensitive devices of the arrayed receiver; and
a control circuit to match overlapping measurement points to the plurality of light sensitive devices of the arrayed receiver for the successive laser light pulses.

9. The system of claim 8, further comprising at least one time-of-flight measurement circuit, responsive to the control circuit to determine distances to objects reflecting the fanned beam at the measurement points.

10. The system of claim 8, wherein the arrayed receiver comprises a one-dimensional array of light sensitive devices.

11. The system of claim 8, wherein the arrayed receiver comprises a two-dimensional array of light sensitive devices.

12. The system of claim 8, wherein the eye safe laser light pulses are spread out in time such that a combination of the eye safe laser light pulses are still eye safe.

13. The system of claim 8, wherein the eye safe laser light pulses are spaced by at least 5 us, and the arrayed receiver includes at least 10 light sensitive devices.

14. The system of claim 8, wherein the first scanning mirror assembly scans faster on an axis parallel to the arrayed receiver.

15. A method comprising:
producing a pulsed beam of laser light;
forming the pulsed beam of laser light into a fanned beam having a wider divergence on a first axis than on a second axis;
scanning the pulsed beam of laser light on the first axis and the second axis in a field of view such that the fanned beam illuminates a plurality of measurement points in the field of view;
receiving a reflection of the fanned beam and imaging the reflection onto an arrayed receiver with a plurality of light sensitive devices; and
determining which light sensitive devices correspond to different measurement points for successive laser light pulses in the pulsed beam of laser light.

16. The method of claim 15, wherein the producing the pulsed beam of laser light comprises producing a plurality of eye safe laser light pulses, wherein the fanned beam associated with successive ones of the plurality of eye safe laser light pulses overlap in the field of view.

17. The method of claim 15, further comprising measuring a time-of-flight of the reflection of the fanned beam for each of the different measurement points.

18. The method of claim 15, wherein the imaging the reflection onto the arrayed receiver comprises imaging the reflection onto a one-dimensional array of light sensitive device in the arrayed receiver.

19. The method of claim 15, wherein the imaging the reflection onto the arrayed receiver comprises imaging the reflection onto a two-dimensional array of light sensitive device in the arrayed receiver.

20. The method of claim 15, wherein the pulsed beam of laser light includes a plurality of eye safe laser light pulses spaced by at least 5 us.
